(19) United States
(12) Patent Application Publication
(10) Pub. No.: US 2015/0302155 A1
(43) Pub. Date: Oct. 22, 2015

(54) METHODS AND SYSTEMS FOR PREDICTING HEALTH CONDITION OF HUMAN SUBJECT

(71) Applicant: Xerox Corporation, Norwalk, CT (US)

(72) Inventors: Vaibhav Rajan, Bangalore (IN); Sakyajit Bhattacharya, Bangalore (IN); Ranjan Shetty K, Karnataka (IN); Amith Sitaram, Karnataka (IN); Vivek G. Raman, Karnataka (IN)

(73) Assignee: Xerox Corporation, Norwalk, CT (US)

(21) Appl. No.: 14/253,941

(22) Filed: Apr. 16, 2014

(51) Int. Cl. G06F 19/00

(52) U.S. Cl. CPC G06F 19/345

(57) ABSTRACT

Disclosed are the methods and systems for classifying one or more patients in one or more categories. A distribution of one or more physiological parameters associated with the one or more patients is determined based on a patient dataset. The one or more physiological parameters correspond to at least a stroke scale score. One or more parameters associated with a copula are estimated by the one or more processors. In an embodiment, the copula defines a joint distribution of the one or more physiological parameters. A classifier is created based on the one or more parameters, wherein the classifier classifies the one or more patients in the one or more categories. The one or more categories correspond to a range of the stroke scale score.

### TECHNICAL FIELD

The presently disclosed embodiments are related, in general, to a prediction model. More particularly, the presently disclosed embodiments are related to methods and systems for predicting a health condition of a human subject.

### BACKGROUND

Healthcare industry is one of the world's largest and fastest growing industries. Typically, healthcare industry encompasses hospital activities, medical practice activities, and other human health related activities. Further, recent years have seen development of various mathematical models for automating the hospital activities. Additionally, such mathematical models may have the capability to perform risk assessment in medical insurance activities.

With increasing complexity of lifestyle of human beings, health related issues, in general, have risen in the past few years. For instance, recent years have seen a rise in cardio-vascular diseases, high blood pressure, and diabetes in young people. Developing a mathematical model that may have the capability to predict the risk of such diseases/conditions might help the people to alter their respective lifestyles. Further, such predictions may help the doctors to provide consultations to such people, accordingly.

### SUMMARY

According to embodiments illustrated herein there is provided a method for classifying one or more patients in one or more categories. The method includes determining, by one or more processors, a distribution of one or more physiological parameters associated with the one or more patients based on a patient dataset. The one or more physiological parameters correspond to at least a stroke scale score. One or more parameters associated with a copula are estimated by the one or more processors. In an embodiment, the copula defines a joint distribution of the one or more physiological parameters. The method further includes creating, by the one or more processors, a classifier based on the one or more parameters, wherein the classifier classifies the one or more patients in the one or more categories. The one or more categories correspond to a range of the stroke scale score.

According to embodiments illustrated herein there is provided a system for classifying one or more patients in one or more categories. The system comprising one or more processors configured to determine a distribution of one or more physiological parameters associated with the one or more patients based on a patient dataset. The one or more physiological parameters correspond to at least a stroke scale score. The one or more processors are further configured to estimate one or more parameters associated with a copula defining a joint distribution of the one or more physiological parameters. Additionally, the one or more processors are configured to create a classifier based on the one or more parameters. The classifier classifies the one or more patients in the one or more categories. The one or more categories correspond to a range of the stroke scale score.

According to embodiments illustrated herein there is provided a computer program product for use with a computing device. The computer program product comprising a non-transitory computer readable medium. The non-transitory computer readable medium stores a computer program code for classifying one or more patients in one or more categories, the computer program code is executable by one or more processors in the computing device to determine a distribution of one or more physiological parameters associated with the one or more patients based on a patient dataset. The one or more physiological parameters correspond to at least a stroke scale score. One or more parameters associated with a copula defining a joint distribution of the one or more physiological parameters are estimated. The computer program code is executable by one or more processors in the computing device to create a classifier based on the one or more parameters. The classifier classifies the one or more patients in the one or more categories, wherein the one or more categories correspond to a range of the stroke scale score.

### BRIEF DESCRIPTION OF DRAWINGS

The accompanying drawings illustrate various embodiments of systems, methods, and other aspects of the disclosure. Any person having ordinary skill in the art will appreciate that the illustrated element boundaries (e.g., boxes, groups of boxes, or other shapes) in the figures represent one example of the boundaries. It may be that in some examples, one element may be designed as multiple elements or that multiple elements may be designed as one element. In some examples, an element shown as an internal component of one element may be implemented as an external component in another, and vice versa. Furthermore, elements may not be drawn to scale.

Various embodiments will hereinafter be described in accordance with the appended drawings, which are provided to illustrate, and not limit, the scope in any manner, wherein similar designations denote similar elements, and in which:

FIG. 1 is a flowchart illustrating a method for creating a classifier for categorizing one or more patients in one or more categories, in accordance with at least one embodiment;

FIG. 2 is a flow diagram illustrating training of a classifier, in accordance with at least one embodiment;

FIG. 3 is a flowchart illustrating another method for training a classifier for categorizing the one or more patients, in accordance with at least one embodiment;

FIG. 4 is a flowchart illustrating a method for determining a stroke score of a human subject, in accordance with at least one embodiment;

FIG. 5 is an environment diagram, in which various embodiments may be implemented; and

FIG. 6 is a block diagram of the application server, in accordance with at least one embodiment.

### DETAILED DESCRIPTION

The present disclosure is best understood with reference to the detailed figures and descriptions set forth herein. Various embodiments are discussed below with reference to the figures. However, those skilled in the art will readily appreciate that the detailed descriptions given herein with respect to the figures are simply for explanatory purposes, as the methods and systems may extend beyond the described embodiments. For example, the teachings presented and the needs of a particular application may yield multiple alternate and suitable approaches to implement the functionality of any detail described herein. Therefore, any approach may extend beyond the particular implementation choices in the following embodiments described and shown.

References to “one embodiment,” “at least one embodiment,” “an embodiment,” “one example”, “an example”, “for example” and so on, indicate that the embodiment(s) or example(s) so described may include a particular feature, structure, characteristic, property, element, or limitation, but that not every embodiment or example necessarily includes that particular feature, structure, characteristic, property, element, or limitation. Furthermore, repeated use of the phrase “in an embodiment” does not necessarily refer to the same embodiment.

A “patient dataset” corresponds to historical data pertaining to one or more human subjects previously examined by a medical practitioner. In an embodiment, the patient dataset includes information pertaining to measured one or more physiological parameters. In an embodiment, the patient dataset is utilizable as a training dataset to train a classifier.

“Patients” refer to one or more human subjects that may receive medical treatment for an ailment/health condition. In an embodiment, prior to receiving the medical treatment, one or more physiological parameters associated with the patients are measured. Based on the measured one or more physiological parameters, a health condition of the patients is determined.

“One or more categories” correspond to a range of a health condition score. In an embodiment, the patients are categorized in the one or more categories based on the measured one or more physiological parameters. In an embodiment, a category in which a patient has been categorized is indicative of a range of the health condition score that may be associated with the patient. For example, if the one or more categories include two categories, i.e., category-1 and category-2. The health conditions score range for the category-1 is 0-25 and that for category-2 is 26-42. If a patient is categorized in category-2, the health condition score of the patient lies in the range of 26-42.

A “stroke score” refers to a score assigned to a human subject based on the measured one or more physiological parameters. In an embodiment, the stroke score is indicative of a severity of the stroke. In an embodiment, the stroke score is in accordance to a National Institute of Health Stroke Scale (NIHSS) score.

“Health condition score” refers to a score assigned to a human subject that is indicative of a severity of a disease or health condition. In an embodiment, the health condition score is determined based on the one or more physiological parameters.

“Human subject” corresponds to a human being, who may be suffering from a health condition or a disease. In an embodiment, the human subject may correspond to a person who seeks a medical opinion on his/her health condition.

“Copula” refers to a multivariate probability distribution of a random variable with d-dimensions. In an embodiment, copulas may decouple a dependence structure of univariate random variables from their marginal distributions.

An “inverse cumulative distribution” refers to an inverse function of a cumulative distribution of a random variable X.

“Probability” shall be broadly construed, to include any calculation of probability; approximation of probability, using any type of input data, regardless of precision or lack of precision; any number, either calculated or predetermined, that simulates a probability; or any method step having an effect of using or finding some data having some relation to a probability.

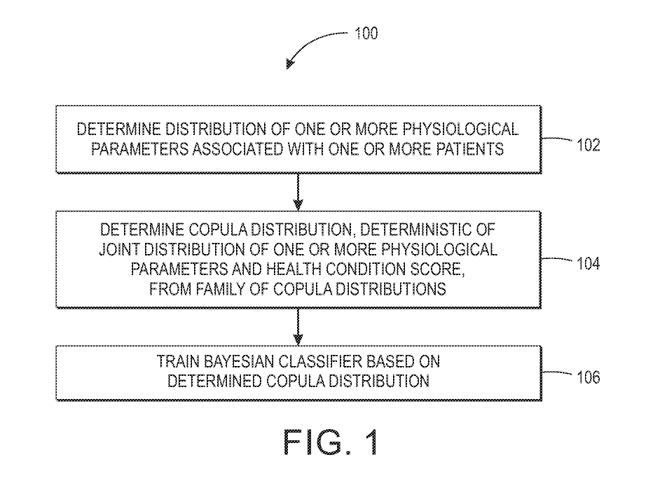

FIG. 1 is a flowchart 100 illustrating a method for creating a classifier for categorizing one or more patients in one or more categories, in accordance with at least one embodiment.

At step 102, a distribution of one or more physiological parameters associated with the one or more patients is determined. Prior to determining the distribution, a patient dataset is extracted from a database server. In an embodiment, the patient dataset includes at least a medical record data associated with each of the one or more patients. In an embodiment, the medical record data includes information pertaining to at least a measure of the one or more physiological parameters associated with a patient. In an embodiment, the one or more physiological parameters may include, but are not limited to, an age, a number of days between an onset of a medical condition and a first medical consultation, a hemoglobin count, an RBC count, a creatinine count, a serum sodium count, a blood albumin count, a blood platelet count, or a complete blood count.

A person having ordinary skill in the art would understand that the scope of the disclosure should not be limited to the above disclosed one or more physiological parameters. In an embodiment, the one or more physiological parameters may further include other types of physiological parameters. Further, the person having ordinary skill in the art would understand that the types of the one or more physiological parameters may vary based on the medical condition. For example, the one or more physiological parameters required for diagnosing a first health condition (e.g., a cardio-vascular disease) may be different from the one or more physiological parameters required for diagnosing a second health condition (e.g., osteoporosis).

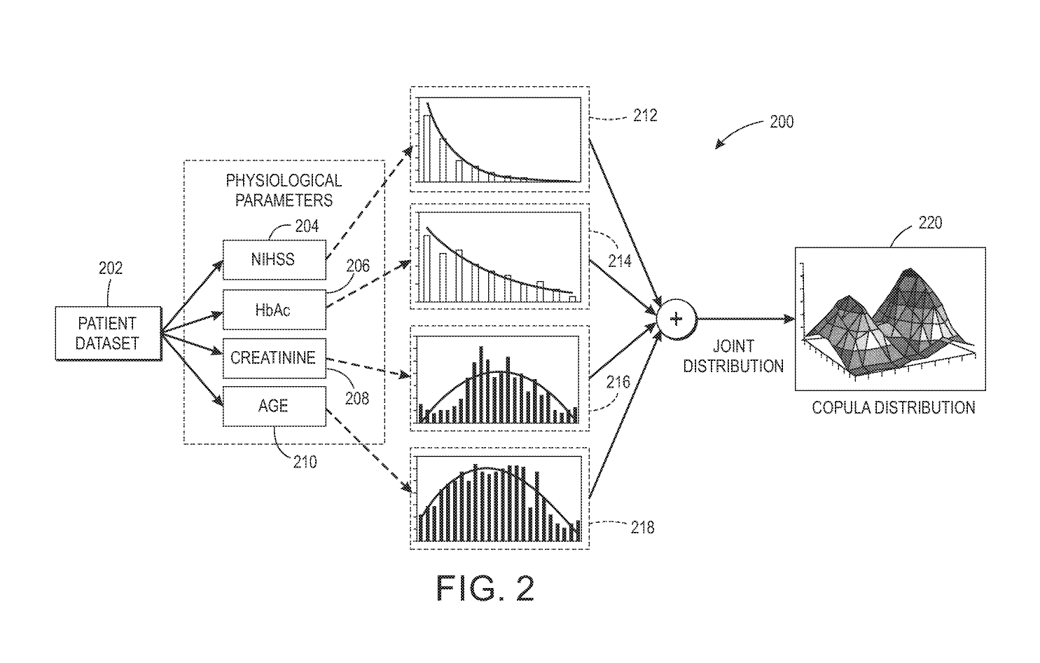

Post extracting the patient dataset, the distribution of each of the one or more physiological parameters is determined on the entire patient dataset. In an embodiment, one or more curve fitting techniques are used to determine the distribution of the one or more physiological parameters. In an embodiment, the curve fitting techniques may involve determining a mathematical equation that can best fit the data points (or measure of the one or more physiological parameters across the patient dataset). For example, the age distribution of the patient dataset usually follows a Gaussian distribution curve. Similarly, the creatinine count distribution can be best described by an exponential distribution. Example distribution of the one or more physiological parameters is described in FIG. 2.

In an embodiment, the patient dataset includes a measure of a health condition score for each of the one or more patients. In an embodiment, the health condition score is determined by the medical practitioner during the physical examination of the one or more patients. In an embodiment, determining the distribution of the one or more physiological parameters involves determining the distribution of the health condition score across the patient dataset. In an embodiment, the health condition score corresponds to a measure of a severity associated with a health condition or a disease. For example, a National Institute of Health Stroke Scale (NIHSS) is a measure of a stroke score.

A person having ordinary skill in the art would understand that the medical record data includes the measure of the health condition score. This health condition score may be used for training the classifier.

At step 104, a copula distribution is determined from a family of copula distributions. In an embodiment, the copula distribution is deterministic of a joint distribution of the one or more physiological parameters and the health condition score. In an embodiment, the one or more physiological parameters correspond to a d-dimensional variable with the various physiological parameters as the dimensions. In an embodiment, following equation is representative of the copula distribution:

F(x¹,x², . . . ,x^{d})=C(F¹(x¹), . . . ,F^{d}(x^{d})) (1)

where,

F^{d}(x^{d}) corresponds to a univariate distribution of a physiological parameter; and

F corresponds to a multivariate distribution of the d-dimensional variable (i.e., the one or more physiological parameters).

In an embodiment, the determined copula distribution best defines the joint distribution of the one or more physiological parameters and the health condition score. To determine the copula distribution, the patient dataset is ranked based on a measure of a physiological parameter from the one or more physiological parameters. For instance, following is an example patient dataset:

TABLE 1
Example patient dataset

| | NIHSS | RBC count | Blood |
|---|---|---|---|
| Patients | Score | (count/μL) | Sugar |
| Patient-1 | 2 | 80 | 120 |
| Patient-2 | 6 | 70 | 190 |
| Patient-3 | 13 | 100 | 148 |
| Patient-4 | 8 | 105 | 90 |
| Patient-5 | 5 | 75 | 95 |
| Patient-6 | 19 | 86 | 70 |
| Patient-7 | 14 | 69 | 136 |

TABLE 2
Ranked patient dataset

| | NIHSS | RBC count | Blood |
|---|---|---|---|
| Patients | Score | (count/μL) | Sugar |
| Patient-1 | 1 | 4 | 4 |
| Patient-2 | 3 | 2 | 7 |
| Patient-3 | 5 | 6 | 6 |
| Patient-4 | 4 | 7 | 2 |
| Patient-5 | 2 | 3 | 3 |
| Patient-6 | 7 | 5 | 1 |
| Patient-7 | 6 | 1 | 5 |

Referring to Table 1 and Table 2, the one or more patients are ranked based on the NIHSS score. For instance, patient-1 is ranked 1^{st} as the NIHSS score of the patient-1 is “2”. Similarly, the patient-6 is ranked 7^{th} as the NIHSS score of the patient-6 is the highest among the other patients listed in the Table 1 (i.e., 19). Further, each physiological parameter from the one or more physiological parameters is ranked across the patient dataset as illustrated in Table 2.

In an embodiment, the copula distribution of the patient dataset and the copula distribution of the ranked patient dataset remain the same. In an embodiment, the copula distribution of the ranked patient dataset is referred as an empirical copula. Following equation represents the empirical copula:

$${C}^{n} ( {u}_{1} , … , {u}_{d} ) = \frac{1}{n} {\sum }_{i = 1}^{n} 1 ( \tilde{{U}_{1}^{i}} \leq {u}_{1} , … , \tilde{{U}_{d}^{i}} \leq {u}_{d} ) \qquad ( 2 )$$

where,

Ũ_{f}^{l}=R_{d}ⁱ/n (3)

R_{d}ⁱ: Rank of the observation; and

n: Number of observations or the number of patients in the patient dataset;

Post defining the empirical copula, one or more parameters associated with the empirical copula are estimated. In an embodiment, the one or more parameters associated with the empirical copula include, but are not limited to, a correlation parameter. In an embodiment, Kendall's Tau based estimator or the Spearman's Rho estimator is used for estimating the one or more parameters of the empirical copula. A person having ordinary skill in the art would understand that the scope of the disclosure should not be limited to estimating the one or more parameters using the Kendall's Tau based estimator or the Spearman's Rho estimator. In an embodiment, various other known methods can be used for estimating the one or more parameters of the empirical copula.

As the copula distribution for the ranked patient dataset (i.e., empirical copula) and the original patient dataset is the same, the one or more parameters estimated for the empirical copula will be representative of the one or more parameters of the copula distribution for the original patient dataset. In an embodiment, the one or more estimated parameters are indicative of the copula distribution defining the joint distribution of the one or more physiological parameters and the health condition score. Some examples of the known copula distributions may include, but are not limited to, a Gaussian copula, a Gumbel copula, etc. Following equation represents a Gaussian copula distribution:

C_{R}^{N}(u₁, . . . ,u_{d})=Ø_{R}(Ø⁻¹(u₁), . . . ,Ø⁻¹(u_{d})) (4)

where,

Ø⁻¹ refers to an inverse cumulative distribution function;

u_{d} refers to a cumulative distribution of the a physiological parameter from the one or more physiological parameters; and

Ø_{R} refers to a joint cumulative distribution function.

At step 106, a Bayesian classifier is trained based on the determined copula distribution. In an embodiment, the Bayesian classifier classifies the one or more patients in one or more classes or categories based on the determined copula. As the copula is representative of the joint distribution or the multivariate distribution between the one or more physiological parameters and the health condition score, the copula is indicative of the relationship between the one or more physiological parameters and the health condition score.

In an embodiment, the one or more classes are determined by segregating the health condition score range. Such classes correspond to the one or more categories in which the one or more patients are categorized. In an embodiment, an input, pertaining to the number of classes or segregation of the health condition score range, is received from an administrator/medical practitioner. In an embodiment, a probability that a patient with a set of physiological parameters corresponds to a class from the one or more classes may be determined using the following equation:

P(cᵢ|x)=f(x|cᵢ)P(cᵢ) (5)

where,

f(x|cᵢ): Joint conditional probability function (determined from the copula); and

P(cᵢ): Prior class probability of the class cᵢ.

In an embodiment, the prior class probability of a class corresponds to a probability determined based on number of patients in a particular class. For example, if there are three classes and 30 patients have been classified in class-1, 25 patients have been classified in class-2 and 45 patients have been classified in class-3. In such a scenario, the prior probabilities of class-1, class-2, and class-3 are 0.3, 0.25, and 0.45, respectively.

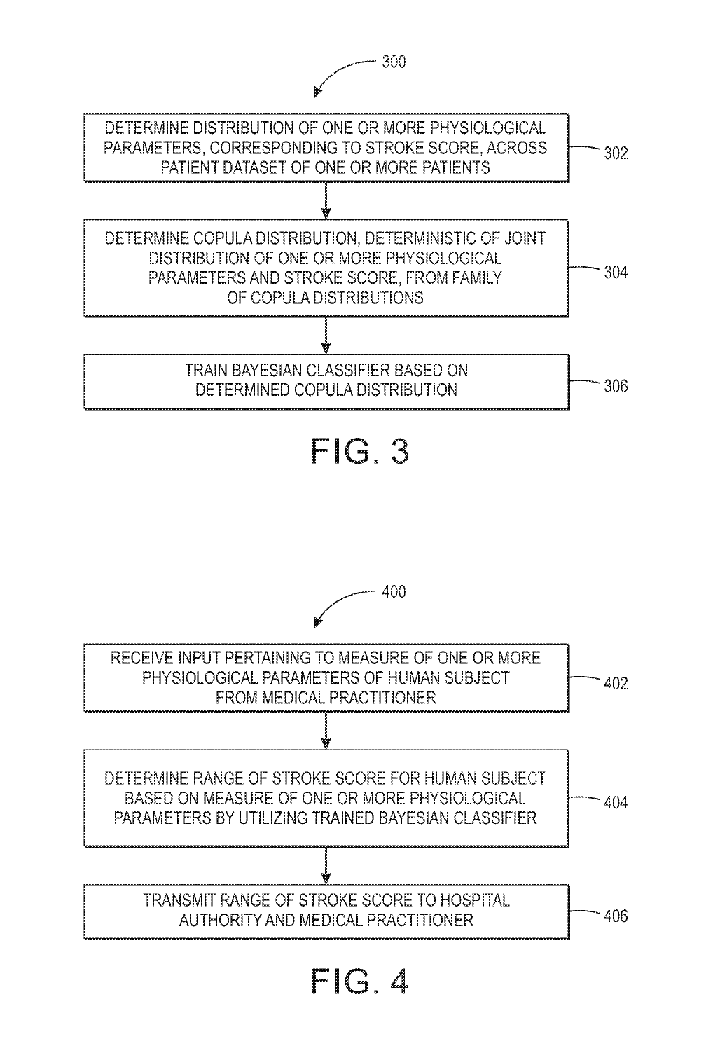

Post training the Bayesian classifier, the Bayesian classifier is used for classifying a human subject in a category from the one or more categories. For example, the human subject arrives at the hospital with one or more symptoms that may be indicative of a medical condition. A medical practitioner may measure the one or more physiological parameters associated with the human subject. The measure of the one or more physiological parameters is fed to the Bayesian classifier and accordingly the Bayesian classifier categorizes the human subject in a category from the one or more categories. Based on the category in which the human subject has been categorized, the medical practitioner may suggest further course of action. The various courses of action have been described later in conjunction with FIG. 3.

A person having ordinary skill in the art would understand that the scope of the disclosure is not limited to training the Bayesian classifier using a copula distribution. In an embodiment, various other classifiers such as a decision tree classifier, support vector machine, and Logistic regression may be used for classifying the human subject in the one or more categories. In an embodiment, such classifiers are first trained on the patient dataset prior to classifying the human subject.

FIG. 2 is a flow diagram 200 illustrating training of the classifier, in accordance with at least one embodiment. The flow diagram 200 is described in conjunction with FIG. 1.

A patient dataset 202 is extracted from the database server. The patient dataset 202 includes information pertaining to the one or more patients and respective measures of the one or more physiological parameters. For example, the patient dataset 202 may include a measure of the NIHSS score (depicted by 204), a hemoglobin measure (depicted by 206), a measure of creatinine (depicted by 208), and age of each of the one or more patients (depicted by 210). The distribution of each of the one or more physiological parameters is determined throughout the patient dataset 202 (as described in the step 102). For instance, the age parameter follows a Gaussian distribution (depicted by 218). Similarly, the NIHSS score follows an exponential distribution curve (depicted by 212). The hemoglobin measure and the creatinine measure follow the exponential distribution (depicted by 214) and the Gaussian distribution (depicted by 216), respectively.

Based on the distribution of the individual physiological parameters, a distribution of the copula is determined (as described in step 104). The copula is indicative of the joint distribution of the one or more physiological parameters. The copula distribution has been depicted by 220. Thereafter, based on the copula distribution, the Bayesian classifier is trained. The Bayesian classifier utilizes the joint probability distribution (determined from the copula) and the distribution of the one or more physiological parameters to classify the one or more patients in the one or more classes.

FIG. 3 is a flow chart 300 illustrating another method for training a classifier for categorizing the one or more patients, in accordance with at least one embodiment. The flow chart 300 has been described in conjunction with FIG. 1.

At step 302, a distribution of the one or more physiological parameters is determined across the patient dataset. In an embodiment, the one or more physiological parameters includes an age, a number of days between an onset of a stroke and a first medical consultation, a hemoglobin count, an RBC count, a creatinine count, a serum sodium count, a blood albumin count, a blood platelet count, or a complete blood count. The determination of the distribution has been described in the step 102. Additionally, along with the determination of the distribution of the one or more physiological parameters, the distribution of a stroke score is determined. In an embodiment, the stroke score corresponds to a score that has been assigned to the patient by the medical practitioner based on the measure of the one or more physiological parameters associated with the patient. In an embodiment, the stroke score is deterministic of a severity of the stroke. In an embodiment, the stroke score is an NIHSS score.

At step 304, a copula distribution, which is deterministic of the joint distribution between the one or more physiological parameters and the stroke score, is determined (as described in the step 104).

At step 306, a Bayesian classifier is trained based on the determined copula distribution (as described in the step 106). In an embodiment, the Bayesian classifier is capable of categorizing the one or more patients in the one or more categories based on the measure of respective physiological parameters. For example, the Bayesian classifier is trained to classify the one or more patients in one of the four classes (as depicted in the following table):

TABLE 3
The one or more classes

| Class | NIHSS score |
|---|---|
| Class-1 | 0-10 |
| Class-2 | 11-20 |
| Class-3 | 21-30 |
| Class-4 | 31-42 |

In an embodiment, an input, pertaining to the number of classes in which the one or more patients have to be categorized, is received from an administrator/medical practitioner. A person having ordinary skill in the art would understand that the scope of the disclosure is not limited to having only four classes. In an embodiment, the range of the stroke score can be further segregated to generate more than four classes.

FIG. 4 is a flowchart 400 illustrating a method for determining a stroke score of a human subject, in accordance with at least one embodiment.

At step 402, an input pertaining to a measure of the one or more physiological parameters is received from a medical practitioner. Prior to receiving the measure of the one or more physiological parameters, the medical practitioner examines the human subject. The examination of the human subject includes measuring the one or more physiological parameters using one or more sensors or blood work tests. Post determining the one or more physiological parameters, the medical practitioner inputs the measured one or more physiological parameters.

A person having ordinary skill in the art would understand that the scope of the disclosure is not limited to measuring the one or more physiological parameters by the medical practitioner. In an embodiment, the human subject may own the one or more sensors through which the human subject may himself/herself measure the one or more physiological parameters. Further, in an embodiment, the human subject may get the one or more physiological parameters measured from a pathological laboratory.

At step 404, a range of the stroke score is determined based on the measured one or more physiological parameters. In an embodiment, the Bayesian classifier is utilized to determine the range of the stroke score. As described in the flowchart 100, the Bayesian classifier is first trained on the patient dataset prior to determination of the range of the stroke score. The Bayesian classifier categorizes the human subject in one category from the one or more categories based on the one or more physiological parameters. In an embodiment, the category in which the human subject has been categorized is indicative of the range of the stroke score (refer table. 3). For example, if the Bayesian classifier categorizes the human subject in the class-2, the range of the stroke score is 11-20.

At step 406, the range of the stroke score is transmitted to at least a hospital authority. Further, the stroke score is transmitted to the medical practitioner. The medical practitioner may determine a severity of the stroke based on the category in which the human subject has been categorized. For example, as the human subject has been categorized in the class-2, the stroke is a moderate stroke. In an embodiment, following table illustrates the severity of the stroke versus the one or more categories:

TABLE 4
Severity of the stroke

| Stroke score range | Stroke severity |
|---|---|
| 0-10 | Minor stroke |
| 11-20 | Moderate stroke |
| 21-30 | Moderate to Severe stroke |
| 31-42 | Severe stroke |

Based on the severity of the stroke, the medical practitioner may plan the treatment of the human subject. For example, the medical practitioner may determine the dosage of the tPA medicine based on the severity of the stroke. Further, the medical practitioner may suggest admission of the human subject in the hospital based on the categorization.

The stroke score may be utilized by the hospital authorities to determine the type of care required by the human subject. Following table illustrates example actions that the hospital may have to take on receiving the stroke score:

TABLE 5
Stroke score versus the hospital disposition

| Stroke score | Hospital Disposition |
|---|---|
| <=5 | Around 80% discharged home |
| 6-13 | Acute in-patient rehabilitation required |
| >=14 | Long term care in nursing facility |

In an embodiment, the care provided by the hospital authority may include, but not limited to, a treatment course for the human subject, an emergency care decision associated with the human subject, or a rehabilitation course for the human subject.

A person having ordinary skills in the art would understand that the scope of the disclosure is not limited to determining the stroke score for the human subject. In an embodiment, scores pertaining to various other health conditions such as Framingham risk score, and coronary heart disease risk score.

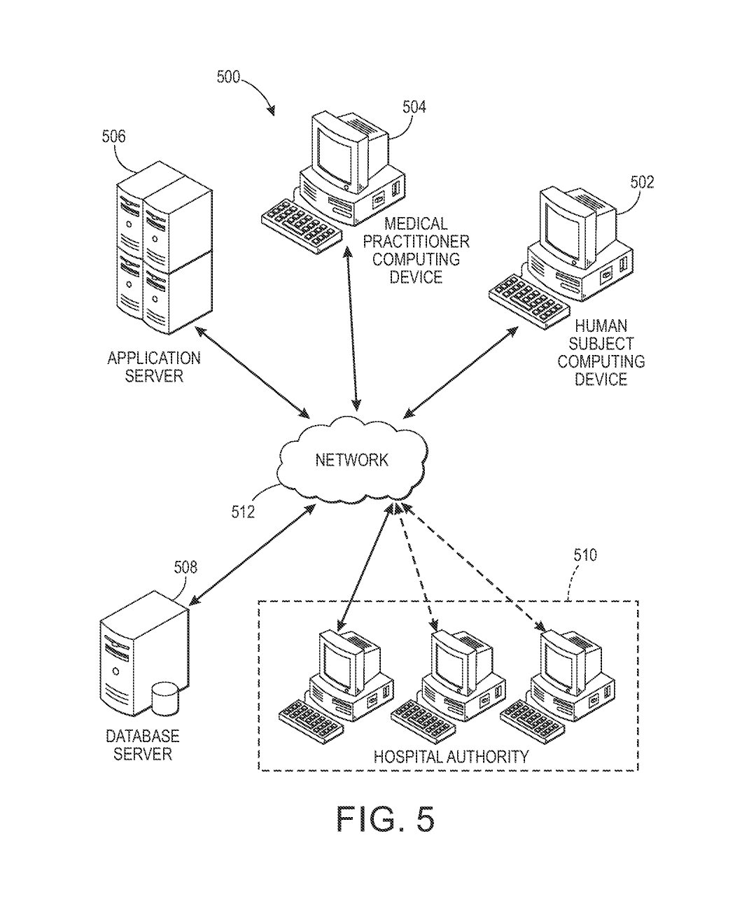

FIG. 5 is a system environment 500, in which various embodiments may be implemented. The system environment 500 includes a human subject computing device 502, a medical practitioner computing device 504, an application server 506, a database server 508, a hospital authority 510, and a network 512.

The human subject computing device 502 corresponds to a computing device owned by a human subject. In an embodiment, the human subject computing device 502 may have one or more coupled sensors. The human subject may utilize the one or more sensors to measure the one or more physiological parameters. The measurements of the one or more physiological parameters are transmitted by the human subject computing device 502 to the application server 506. In an alternate embodiment, the human subject may visit the medical practitioner, where the medical practitioner examines the human subject to determine the one or more physiological parameters. In another embodiment, the human subject may visit a laboratory that may have the one or more sensors to measure the one or more physiological parameters. Thereafter, the laboratory may transmit the data pertaining to the one or more physiological parameters to the application server 506. In an embodiment, the human subject computing device 502 may be realized using any computing device such as a desktop, a laptop, a personal digital assistant (PDA), a tablet computer, and the like.

The medical practitioner computing device 504 corresponds to a computing device that is operable by the medical practitioner. In an embodiment, the medical practitioner computing device 504 may have the one or more coupled sensors. Such sensors are utilizable to measure the one or more physiological parameters associated with the human subject. The medical practitioner computing device 504 may transmit the measured one or more physiological parameters to the application server 506. In an embodiment, the medical practitioner computing device 504 may receive the health condition score from the application server 506. Based on the health condition score, the medical practitioner may determine a further course of action. Further, the medical practitioner computing device 504 may query the database server 508 to extract the medical record data pertaining to the human subject. In an embodiment, the medical practitioner computing device 504 may be realized using any computing device such as a desktop, a laptop, a personal digital assistant (PDA), a tablet computer, and the like.

The application server 506 is configured to determine the health condition score of the human subject. In an embodiment, the application server 506 includes the classifier having the capability of determining the health condition score associated with the human subject. Additionally, the classifier categorizes the human subject in a category from the one or more categories based on the health condition score. In an embodiment, the application server 506 trains the classifier based on the patient dataset. The application server 506 extracts the patient dataset from the database server 508. The training of the classifier has been described above in conjunction with FIG. 1. The application server 506 transmits the health condition score to the medical practitioner computing device 504 and the hospital authority 510. In an embodiment, the application server 506 may present a user interface on the medical practitioner computing device 504 through which the health conditions score is displayed to the medical practitioner. In an embodiment, the application server 506 may be realized through various types of servers such as, but not limited to, Java server, .NET framework, and Base4 server.

A person having ordinary skill in the art would understand that scope of the disclosure is not limited having the application server 506 as a separate entity. In an embodiment, the application server 506 may be embedded in the medical practitioner computing device 504.

In an embodiment, the database server 508 is operable to store the patient dataset. In an embodiment, the patient dataset includes information pertaining to the measure of the one or more physiological parameters associated with the one or more patients in the patient dataset. Further, the database server 508 includes information pertaining to the medical record data of the human subject. In an embodiment, the database server 508 may receive a query from the application server 506, the hospital authority 510, and/or the medical practitioner computing device 504 to extract the patient dataset or the medical record data associated with the human subject. The database server 508 may be realized through various technologies such as, but not limited to, Microsoft® SQL server, Oracle, and My SQL. In an embodiment, the medical practitioner computing device 504, the hospital authority 510, and/or the application server 506 may connect to the database server 508 using one or more protocols such as, but not limited to, Open Database Connectivity (ODBC) protocol and Java Database Connectivity (JDBC) protocol.

A person having ordinary skill in the art would understand that scope of the disclosure is not limited to having the database server 508 as a separate entity. In an embodiment, the database server 508 may be embedded along with application server 506.

The hospital authority 510 corresponds to a hospital infrastructure that includes at least one computing device. The computing device in the hospital authority 510 receives the health condition score from the application server 506. Based on the health condition score, the computing device in the hospital authority may inform one or more departments in the hospital authority 510 to make preparations for disposition of the human subject in accordance with the health condition score associated with the human subject.

The network 512 corresponds to a medium through which content and messages flow between various devices of the system environment 500 (e.g., the human subject computing device 502, the medical practitioner computing device 504, the application server 506, the database server 508, and the hospital authority 510). Examples of the network 512 may include, but are not limited to, a Wireless Fidelity (Wi-Fi) network, a Wireless Area Network (WAN), a Local Area Network (LAN), or a Metropolitan Area Network (MAN). Various devices in the system environment 500 can connect to the network 512 in accordance with various wired and wireless communication protocols such as Transmission Control Protocol and Internet Protocol (TCP/IP), User Datagram Protocol (UDP), and 2G, 3G, or 4G communication protocols.

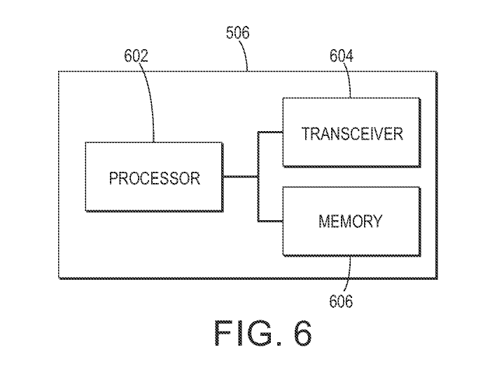

FIG. 6 is a block diagram of the application server 506, in accordance with at least one embodiment. The application server 506 includes a processor 602, a memory 604, and a transceiver 606.

The processor 602 is coupled to the memory 604 and the transceiver 606. The processor 602 includes suitable logic, circuitry, and/or interfaces that are operable to execute one or more instructions stored in the memory 604 to perform predetermined operation. The memory 604 may be operable to store the one or more instructions. The processor 602 may be implemented using one or more processor technologies known in the art. Examples of the processor 602 include, but are not limited to, an X86 processor, a RISC processor, an ASIC processor, a CISC processor, or any other processor.

The memory 604 stores a set of instructions and data. Some of the commonly known memory implementations include, but are not limited to, a random access memory (RAM), a read only memory (ROM), a hard disk drive (HDD), and a secure digital (SD) card. Further, the memory 604 includes the one or more instructions that are executable by the processor 602 to perform specific operations. It will be apparent to a person having ordinary skills in the art that the one or more instructions stored in the memory 604 enables the hardware of the application server 506 to perform the predetermined operation.

The transceiver 606 transmits and receives messages and data to/from various devices of the system environment 500 (e.g., the human subject computing device 502, the medical practitioner computing device 504, the database server 508, and the hospital authority 510). Examples of the transceiver 606 may include, but are not limited to, an antenna, an Ethernet port, a USB port or any other port that can be configured to receive and transmit data. The transceiver 606 transmits and receives data/messages in accordance with the various communication protocols, such as, TCP/IP, UDP, and 2G, 3G, or 4G communication protocols.

In an embodiment, the application server 506 performs the method described in the flowcharts 100, 300, and 400.

The disclosed embodiments encompass numerous advantages. Creating a classifier capable of determining a health condition score of a human subject may help the medical practitioner to determine the prognosis of a disease. Accordingly, the medical practitioner may determine a further course of treatment. Additionally, the health condition score may be transmitted to the hospital authority, which based on the health condition score, may make arrangements for disposition of the human subject. As a computing device (i.e., application server) is being used to determine the health condition score, the time of the medical practitioner for determining the health condition score is reduced. The time so saved, may be used by the medical practitioner to determine the further course of action for the patient.

The disclosed methods and systems, as illustrated in the ongoing description or any of its components, may be embodied in the form of a computer system. Typical examples of a computer system include a general-purpose computer, a programmed microprocessor, a micro-controller, a peripheral integrated circuit element, and other devices, or arrangements of devices that are capable of implementing the steps that constitute the method of the disclosure.

The computer system comprises a computer, an input device, a display unit and the Internet. The computer further comprises a microprocessor. The microprocessor is connected to a communication bus. The computer also includes a memory. The memory may be Random Access Memory (RAM) or Read Only Memory (ROM). The computer system further comprises a storage device, which may be a hard-disk drive or a removable storage drive, such as, a floppy-disk drive, optical-disk drive, and the like. The storage device may also be a means for loading computer programs or other instructions into the computer system. The computer system also includes a communication unit. The communication unit allows the computer to connect to other databases and the Internet through an input/output (I/O) interface, allowing the transfer as well as reception of data from other sources. The communication unit may include a modem, an Ethernet card, or other similar devices, which enable the computer system to connect to databases and networks, such as, LAN, MAN, WAN, and the Internet. The computer system facilitates input from a user through input devices accessible to the system through an I/O interface.

In order to process input data, the computer system executes a set of instructions that are stored in one or more storage elements. The storage elements may also hold data or other information, as desired. The storage element may be in the form of an information source or a physical memory element present in the processing machine.

The programmable or computer-readable instructions may include various commands that instruct the processing machine to perform specific tasks, such as steps that constitute the method of the disclosure. The systems and methods described can also be implemented using only software programming or using only hardware or by a varying combination of the two techniques. The disclosure is independent of the programming language and the operating system used in the computers. The instructions for the disclosure can be written in all programming languages including, but not limited to, ‘C’, ‘C++’, ‘Visual C++’ and ‘Visual Basic’. Further, the software may be in the form of a collection of separate programs, a program module containing a larger program or a portion of a program module, as discussed in the ongoing description. The software may also include modular programming in the form of object-oriented programming. The processing of input data by the processing machine may be in response to user commands, the results of previous processing, or from a request made by another processing machine. The disclosure can also be implemented in various operating systems and platforms including, but not limited to, ‘Unix’, DOS′, ‘Android’, ‘Symbian’, and ‘Linux’.

The programmable instructions can be stored and transmitted on a computer-readable medium. The disclosure can also be embodied in a computer program product comprising a computer-readable medium, or with any product capable of implementing the above methods and systems, or the numerous possible variations thereof.

Various embodiments of the methods and systems for predicting health condition of human subject have been disclosed. However, it should be apparent to those skilled in the art that modifications in addition to those described, are possible without departing from the inventive concepts herein. The embodiments, therefore, are not restrictive, except in the spirit of the disclosure. Moreover, in interpreting the disclosure, all terms should be understood in the broadest possible manner consistent with the context. In particular, the terms “comprises” and “comprising” should be interpreted as referring to elements, components, or steps, in a non-exclusive manner, indicating that the referenced elements, components, or steps may be present, or utilized, or combined with other elements, components, or steps that are not expressly referenced.

A person having ordinary skills in the art will appreciate that the system, modules, and sub-modules have been illustrated and explained to serve as examples and should not be considered limiting in any manner. It will be further appreciated that the variants of the above disclosed system elements, or modules and other features and functions, or alternatives thereof, may be combined to create other different systems or applications.

Those skilled in the art will appreciate that any of the aforementioned steps and/or system modules may be suitably replaced, reordered, or removed, and additional steps and/or system modules may be inserted, depending on the needs of a particular application. In addition, the systems of the aforementioned embodiments may be implemented using a wide variety of suitable processes and system modules and is not limited to any particular computer hardware, software, middleware, firmware, microcode, or the like.

The claims can encompass embodiments for hardware, software, or a combination thereof.

It will be appreciated that variants of the above disclosed, and other features and functions or alternatives thereof, may be combined into many other different systems or applications. Presently unforeseen or unanticipated alternatives, modifications, variations, or improvements therein may be subsequently made by those skilled in the art, which are also intended to be encompassed by the following claims.

What is claimed is:

1. A method for classifying one or more patients in one or more categories, the method comprising:
determining, by one or more processors, a distribution of one or more physiological parameters associated with the one or more patients based on a patient dataset, wherein the one or more physiological parameters comprise at least a stroke score;
estimating, by the one or more processors, one or more parameters associated with a copula defining a joint distribution of the one or more physiological parameters; and
creating, by the one or more processors, a classifier based on the one or more parameters, wherein the classifier classifies the one or more patients in the one or more categories, wherein the one or more categories correspond to a range of the stroke score.

2. The method of claim 1, wherein the one or more physiological parameters comprise at least one of an age, a number of days between an onset of a stroke and a first medical consultation, a hemoglobin count, a RBC count, a creatinine count, a serum sodium count, a blood albumin count, a blood platelet count, or a complete blood count.

3. The method of claim 1, wherein the classifier is a Bayesian classifier.

4. The method of claim 1 further comprising categorizing, by the one or more processors, a human subject, different from the one or more patients, in the one or more categories based on one or more physiological parameters associated with the human subject, wherein the stroke score of the human subject is unknown.

5. The method of claim 4 further comprising determining, by the one or more processors, at least one of a treatment course for the human subject, an emergency care decision associated with the human subject, or a rehabilitation course for the human subject, based on the categorization of the human subject in the one or more categories.

6. The method of claim 1 further comprising transforming, by the one or more processors, the patient dataset into a ranked dataset, wherein the ranked dataset corresponds to the patient dataset sorted based on a physiological parameter from the one or more physiological parameters.

7. A method for categorizing one or more patients in one or more categories, the method comprising:
creating, by one or more processors, a classifier based on a patient dataset comprising a measure of one or more physiological parameters of the one or more patients, wherein the one or more physiological parameters comprise at least a measure of a stroke score; and
classifying, by the one or more processors, the one or more patients in the one or more categories based on the classifier, wherein the one or more categories correspond to a range of the stroke score.

8. The method of claim 7, wherein the one or more physiological parameters comprise at least one of an age, a number of days between an onset of a stroke and a first medical consultation, a hemoglobin count, a RBC count, a creatinine count, a serum sodium count, a blood albumin count, a blood platelet count, or a complete blood count.

9. The method of claim 7 further comprising training, by the one or more processors, the classifier based on one or more machine learning techniques comprising at least one of a Support Vector Machine (SVM), a Logistic Regression, a Naïve Bayes Classifier, a Decision Tree Classifier, or a Copula-based Classifier.

10. The method of claim 7, wherein the classifier is a Bayesian classifier.

11. The method of claim 7 further comprising categorizing, by the one or more processors, a human subject, different from the one or more patients, in the one or more categories based on one or more physiological parameters associated with the human subject, wherein the stroke score of the human subject is unknown.

12. The method of claim 11 further comprising determining, by the one or more processors, at least one of a treatment course for the human subject, an emergency care decision associated with the human subject, or a rehabilitation course for the human subject, based on the categorization of the human subject in the one or more categories.

13. A system for classifying one or more patients in one or more categories, the system comprising:
one or more processors configured to:
determine a distribution of one or more physiological parameters associated with the one or more patients based on a patient dataset, wherein the one or more physiological parameters comprise at least a stroke score;
estimate one or more parameters associated with a copula defining a joint distribution of the one or more physiological parameters; and
create a classifier based on the one or more parameters, wherein the classifier classifies the one or more patients in the one or more categories, wherein the one or more categories correspond to a range of the stroke score.

14. The system of claim 13, wherein the one or more physiological parameters comprise at least one of an age, a number of days between an onset of a stroke and a first medical consultation, a hemoglobin count, a RBC count, a creatinine count, a serum sodium count, a blood albumin count, a blood platelet count, or a complete blood count.

15. The system of claim 13, wherein the classifier is a Bayesian classifier.

16. The system of claim 13, wherein the one or more processors are further configured to categorize a human subject, different from the one or more patients, in the one or more categories based on one or more physiological parameters associated with the human subject, wherein the stroke score of the human subject is unknown.

17. The system of claim 16, wherein the one or more processors are further configured to determine at least one of a treatment course for the human subject, an emergency care decision associated with the human subject, or a rehabilitation course for the human subject, based on the categorization of the human subject in the one or more categories.

18. A computer program product for use with a computing device, the computer program product comprising a non-transitory computer readable medium, the non-transitory computer readable medium stores a computer program code for classifying one or more patients in one or more categories, the computer program code is executable by one or more processors in the computing device to:
determine a distribution of one or more physiological parameters associated with the one or more patients based on a patient dataset, wherein the one or more physiological parameters comprise at least a stroke score;
estimate one or more parameters associated with a copula defining a joint distribution of the one or more physiological parameters; and
create a classifier based on the one or more parameters, wherein the classifier classifies the one or more patients in the one or more categories, wherein the one or more categories correspond to a range of the stroke score.

19. The computer program product of claim 18, wherein the one or more physiological parameters comprise at least one of an age, a number of days between an onset of a stroke and a first medical consultation, a hemoglobin count, a RBC count, a creatinine count, a serum sodium count, a blood albumin count, a blood platelet count, or a complete blood count.

20. The computer program product of claim 18, wherein the classifier is a Bayesian classifier.
